(19) United States
(12) Patent Application Publication
(10) Pub. No.: US 2007/0160027 A1
(43) Pub. Date: Jul. 12, 2007

(54) DYNAMIC POWER SAVE MODES

(76) Inventors: Alaa Hilal Muqattash, San Diego, CA (US); Ghobad Heidari-Bateni, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/615,304

(22) Filed: Dec. 22, 2006

Related U.S. Application Data
(60) Provisional application No. 60/754,235, filed on Dec. 27, 2005.
(60) Provisional application No. 60/765,980, filed on Feb. 6, 2006.
(60) Provisional application No. 60/775,518, filed on Feb. 21, 2006.

(51) Int. Cl. H04B 7/212

(52) U.S. Cl. 370/347; 370/395.5

(57) ABSTRACT

A mechanism that enables power sensitive communication devices to utilize the hibernation power saving mechanism offered by existing protocols is provided. In circumstances where there is no data buffered for transmission for a network device, that device can be permitted to hibernate. Alternatively, where there is data buffered for transmission for a network device, that device can be permitted to remain active. A device that receives a traffic indication that contains its identification can be configured to remain in the active mode for as long as traffic indications included in received beacons contain its identification.

### CROSS-REFERENCE TO RELATED APPLICATIONS

This application claims priority from U.S. Provisional Patent Applications Ser. No. 60/754,235 filed Dec. 27, 2005, 60/765,980 filed Feb. 6, 2006, 60/775,518 filed Feb. 21, 2006, each of which is hereby incorporated herein by reference in the respective entirety of each.

### TECHNICAL FIELD

The present invention relates to communications, and more particularly, some embodiments relate to power save modes in a communication system.

### DESCRIPTION OF THE RELATED ART

With the many continued advancements in communications technology, more and more devices are being introduced in both the consumer and commercial sectors with advanced communications capabilities. Additionally, advances in processing power and low-power consumption technologies, as well as advances in data coding techniques have led to the proliferation of wired and wireless communications capabilities on a more widespread basis.

For example, communication networks, both wired and wireless, are now commonplace in many home and office environments. Such networks allow various heretofore independent devices to share data and other information to enhance productivity or simply to improve their convenience to the user. One such communication network that is gaining widespread popularity is an exemplary implementation of a wireless network such as that specified by the WiMedia-MBOA (Multiband OFDM Alliance). Other exemplary networks include the Bluetooth® communications network and various IEEE standards-based networks such as 802.11 and 802.16 communications networks, to name a few.

With the proliferation of portable and low-power consumption devices, techniques for extending battery life or otherwise reducing power consumption have been developed. Consequently, an important goal in the design of wireless networks is to enable long operation time for battery powered devices. An effective method to extend battery life is to enable devices to turn off completely (i.e., hibernate) for long periods of time, where a long period is relative to the superframe duration.

For example, one way to utilize the hibernation power saving mechanism as outlined by the WiMedia MAC protocol is to provide two power management modes in which a device can operate: the active mode and the hibernation mode. Devices in the active mode transmit and receive beacons in every superframe. Devices in the hibernation mode hibernate for multiple superframes and do not transmit or receive in those superframes, thus saving energy. These periods are typically fixed periodic active and hibernation periods. However, because these active and hibernation periods affect throughput and energy consumption, fixed periods do not perform well in all situations.

For example, if the active period is chosen to be too small, there may not be enough time available to send or receive desired communications. This could potentially degrade network throughput. If, on the other hand, the active period is too large, the device has less time to hibernate, potentially increasing its energy consumption. At low loads, in particular, large active periods are unnecessary. If the hibernation period is too long, then the source device may need to wait for a long period of time before the target is active, potentially causing throughput degradation and buffer overflow. Thus, static active and hibernation periods do not always perform well.

### BRIEF SUMMARY OF EMBODIMENTS OF THE INVENTION

According to one embodiment of the invention a mechanism that enables battery-powered or other power sensitive communication devices to utilize the hibernation power saving mechanism offered by existing protocols is provided. This can allow devices to dynamically change the durations of hibernation and active modes via WiNET negotiation.

In accordance with one feature, in circumstances where there is no data buffered for transmission for a network device, that device can be permitted to hibernate. Alternatively, where there is data buffered for transmission for a network device, that device can be permitted to remain active. Further, a mechanism can be provided for the traffic source to provide information to the target regarding the next time that the source may have traffic for that target.

In the example environment, the Traffic Indication Map (TIM) Information Element (IE) can provide a mechanism to indicate that an active device has data buffered for transmission via Prioritized Contention Access (PCA) for one or more of its neighbors. For example, the TIM can be included in a beacon in a superframe. The TIM can indicate that there is traffic for a target device during that superframe. In one embodiment, the TIM only provides information about that superframe, no traffic information is provided for subsequent superframes.

In terms of the example environment, in one embodiment the device can remain asleep for a variable period of X superframes, and awaken in order to receive traffic information from other network devices that may wish to communicate with it. For example, a WiNET Traffic Indication (WTI) can indicate that there is traffic in subsequent superframes. Thus, the device can remain asleep for a variable period of superframes, e.g., until the subsequent superframe that has traffic. The WTI can be encoded in the source's beacon.

According to another embodiment, a first network device that wishes to communicate with one of its hibernating neighbors can wait until that neighbor goes into an active mode. When the neighbor goes into the active mode, that neighbor's identification, for example its Device Address (DevAddr) and the recommend hibernation period can be included in the first device's traffic indication, e.g., the WTI.

A device that receives a traffic indication, for example a WTI, that contains its identification (e.g., DevAddr) can be configured to remain in the active mode for as long as traffic indications included in received beacons contain its identification. The traffic indicator thus acts as a “wake up” message for a network device.

According to one embodiment as mentioned above, the sending device can include a recommended hibernation period. This recommended hibernation period can provide information to the target device regarding how long the device should hibernate before waking up again to receive traffic from the source device sending this recommendation.

In scenarios where no data is buffered for transmission to a network device, that device will not receive a traffic indicator that contains its identification, and is able to hibernate. On the other hand, where there is data buffered for transmission to a target network device, or it is otherwise known that the target is designate to receive traffic, the target device receives a traffic indicator that contains its identification. The target device can also receive a recommended hibernation period or other indication of when the communication is desired or scheduled.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is a block diagram illustrating one possible configuration of a wireless network that can serve as an example environment in which the present invention can be implemented.

FIG. 2 is a diagram illustrating bandwidth that can be divided into superframes, which in turn can be divided into time slots.

FIG. 3 is a diagram illustrating one example of the power saving mechanism in accordance with one embodiment of the invention.

FIG. 4 is a flowchart illustrating an example method in accordance with the systems and methods described herein.

The figures are not intended to be exhaustive or to limit the invention to the precise form disclosed. It should be understood that the invention can be practiced with modification and alteration, and that the invention be limited only by the claims and the equivalents thereof.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

This present invention in one embodiment proposes a dynamic mechanism for choosing active and hibernation periods. The mechanism is primarily useful for devices communicating across a communication channel. The communication channel can be that of a communication network or other communication channel. One example communication channel is a wireless network. An exemplary implementation of a wireless network is a network as specified by the WiMedia-MBOA (Multiband OFDM Alliance), although the invention can be implemented with other networks and communication channels as well.

Before describing the invention in detail, it is useful to describe an example environment in which the invention can be implemented. One such example is a wireless beaconing network in which multiple electronic devices (for example, computers and computing devices, cellular telephones, personal digital assistants, motion and still cameras, among others) can communicate and share data, content and other information with one another. One example of such a network is that specified by the WiMedia standard (within WiMedia and Multi-Band OFDM Alliance). From time-to-time, the present invention is described herein in terms of a distributed network or in terms of the WiMedia standard. Description in terms of these environments is provided to allow the various features and embodiments of the invention to be portrayed in the context of an exemplary application. After reading this description, it will become apparent to one of ordinary skill in the art how the invention can be implemented in different and alternative environments. Indeed, applicability of the invention is not limited to a distributed wireless network, nor is it limited to the MB-UWB standard described as one implementation of the example environment.

Most network standards specify policies or rules that govern the behavior of network connected devices. The WiMedia standard specifies the mechanism and policies that are to be followed by W-USB and WiNet compliant devices in order to allow for an ad hoc and distributed network of such devices to operate efficiently.

In most distributed networks, the network of the devices is maintained by requiring all devices to announce parameters such as their presence, their capabilities and their intentions for reserving transmission slots and so on. For example, with the WiMedia standard, this can be done during what are referred to as beacon period time slots. According to this standard, devices joining the network are expected to monitor the beacon period to learn about the network status and parameters before attempting to use the network. In other network configurations, beacon periods are similarly used to allow management of network devices as described more fully below. Thus, beacon periods are one form of window or network period during which scheduling or other housekeeping activities can be conducted. Beacon periods in the above-referenced standard, and other time periods used for scheduling or other housekeeping chores in other network configurations, are generally referred to as scheduling windows.

Devices are typically allowed to enter a power save mode to conserve power and possibly prolong operation. For example, battery operated devices may enter a sleep mode or even a deep-sleep mode, wherein one or more of their functions are diminished or shut down in order to conserve power. Depending on the environment, devices may be allowed to enter into a sleep mode for short or long periods of time. For example, a sleep mode can be an energy-saving mode of operation in which some or all components are shut down or their operation limited. Many battery-operated devices, such as notebook computers, cell phones, and other portable electronic devices support one or more levels of a sleep mode. For example, when a notebook computer goes into one level of sleep mode, it may turn off the hard drive and still allow the user to perform operations, only powering up the hard drive when access is needed. In a deeper level of sleep, the computer may further turn off the display. In yet a further level of sleep, the computer may enter a hibernate state. Likewise, other electronic devices communicating across a communication channel may have similar sleep states and may power down unnecessary or unused components, including an RF transceiver, depending on a number of factors such as elapsed time, activities and so on. As described below, in accordance with one embodiment, devices may be prompted to enter a sleep mode upon completion of scheduling or other housekeeping activities and be configured to awaken for scheduled activities such as, for example, communication activities.

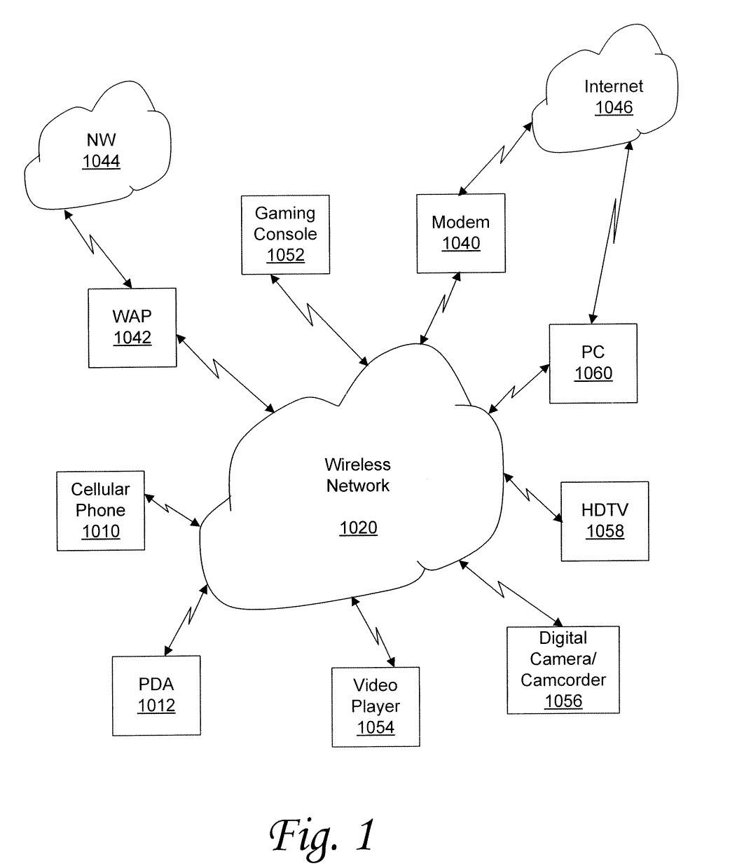

FIG. 1 is a block diagram illustrating one possible configuration of a wireless network that can serve as an example environment in which the present invention can be implemented. Referring now to FIG. 1, a wireless network 1020 is provided to allow a plurality of electronic devices to communicate with one another without the need for wires or cables between the devices. A wireless network 1020 can vary in coverage area depending on a number of factors or parameters including, for example, the transmit power levels and receive sensitivities of the various electronic devices associated with the network. Examples of wireless networks can include the various IEEE and other standards as described above, as well as other wireless network implementations.

With many applications, the wireless network 1020 operates in a relatively confined area, such as, for example, a home or an office. The example illustrated in FIG. 1 is an example of an implementation such as that which may be found in a home or small office environment. Of course wireless communication networks and communication networks in general are found in many environments outside the home and office as well. In the example illustrated in FIG. 1, wireless network 1020 includes a communication device to allow it to communicate with external networks. More particularly, in the illustrated example, wireless network 1020 includes a modem 1040 to provide connectivity to an external network such as the Internet 1046, and a wireless access point 1042 that can provide external connectivity to another network 1044.

Also illustrated in the example wireless network 1020 are portable electronic devices such as a cellular telephone 1010 and a personal digital assistant (PDA) 1012. Like the other electronic devices illustrated in FIG. 1, cellular telephone 1010 and PDA 1012 can communicate with wireless network 1020 via the appropriate wireless interface. Additionally, these devices may be configured to further communicate with an external network. For example, cellular telephone 1010 is typically configured to communicate with a wide area wireless network by way of a base station.

Additionally, the example environment illustrated in FIG. 1 also includes examples of home entertainment devices connected to wireless network 1020. In the illustrated example, electronic devices such as a gaming console 1052, a video player 1054, a digital camera/camcorder 1056, and a high definition television 1058 are illustrated as being interconnected via wireless network 1020. For example, a digital camera or camcorder 1056 can be utilized by a user to capture one or more still picture or motion video images. The captured images can be stored in a local memory or storage device associated with digital camera or camcorder 1056 and ultimately communicated to another electronic device via wireless network 1020. For example, the user may wish to provide a digital video stream to a high definition television set 1058 associated with wireless network 1020. As another example, the user may wish to upload one or more images from digital camera 1056 to his or her personal computer 1060 or to the Internet 1046. This can be accomplished by wireless network 1020. Of course, wireless network 1020 can be utilized to provide data, content, and other information sharing on a peer-to-peer or other basis, as the provided examples serve to illustrate.

Also illustrated is a personal computer 1060 or other computing device connected to wireless network 1020 via a wireless air interface. As depicted in the illustrated example, personal computer 1060 can also provide connectivity to an external network such as the Internet 1046.

In the illustrated example, wireless network 1020 is implemented so as to provide wireless connectivity to the various electronic devices associated therewith. Wireless network 1020 allows these devices to share data, content, and other information with one another across wireless network 1020. Typically, in such an environment, the electronic devices would have the appropriate transmitter, receiver, or transceiver to allow communication via the air interface with other devices associated with wireless network 1020. These electronic devices may conform to one or more appropriate wireless standards and, in fact, multiple standards may be in play within a given neighborhood. Electronic devices associated with the network typically also have control logic configured to manage communications across the network and to manage the operational functionality of the electronic device. Such control logic can be implemented using hardware, software, or a combination thereof. For example, one or more processors, ASICs, PLAs, and other logic devices or components can be included with the device to implement the desired features and functionality. Additionally, memory or other data and information storage capacity can be included to facilitate operation of the device and communication across the network.

Electronic devices operating as a part of wireless network 1020 are sometimes referred to herein as network devices, members or member devices of the network or devices associated with the network. In one embodiment devices that communicate with a given network may be members or merely in communication with the network.

Some communication networks are divided into periods or frames that can be used for communication and other activities. For example, as discussed above, some networks have a scheduling window such as, for example, a beacon period, for scheduling upcoming communication activities. Also, some networks have a communication window during which such communication activities take place. In the WiMedia-MBOA standard, the bandwidth is divided into superframes, which in turn are divided into time slots for the transmission and reception of data by the various electronic devices associated with the network.

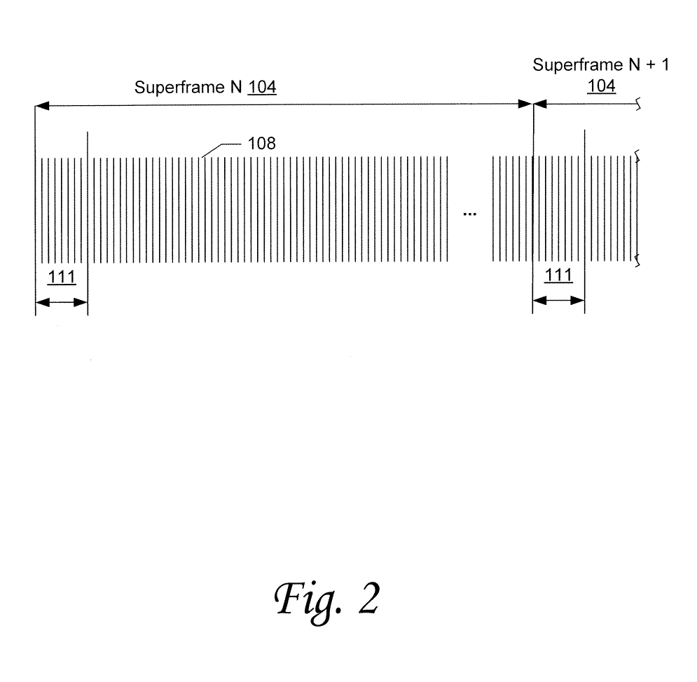

An example of such time slots are illustrated in FIG. 2. Referring now to FIG. 2, in this exemplary environment, the communication bandwidth is divided into superframes 104 (two illustrated), each superframe 104 itself being divided into a plurality of timeslots referred to as Media Access Slots 108. In the example environment, there are 256 media access slots 108 in each superframe 104, although other allocations are possible. Additionally, at the beginning of each superframe 104 is a beacon period 111, which is comprised of a plurality of beaconing slots. In some networks, the beacon period 111 is a period during which devices reserve timeslots and exchange other housekeeping or status information. For example, in the WiMedia-MBOA distributed wireless network, the superframes comprise a beacon period 111, during which devices are awake and receive beacons from other devices. Superframes in the above-referenced standard, and other time periods used for communications among devices in other network configurations, with or without scheduling windows, are generally referred to herein as communication windows. As noted above, for clarity of description the present invention is described in terms of the example environment, and thus is at times described using the terms superframe and beacon period. As would be apparent to one of ordinary skill in the art after reading this description, the invention applies to other communication formats, including the more general case utilizing scheduling windows and communication windows. Additionally, the invention is not limited to applications where the bandwidth is divided into frames or windows, but can be generally applied to communication channels and networks of various protocols and configurations.

Having thus described an example environment in which the invention can be implemented, various features and embodiments of the invention are now described in further detail. Description may be provided in terms of this example environment for ease of discussion and understanding only. After reading the description herein, it will become apparent to one of ordinary skill in the art that the present invention can be implemented in any of a number of different communication environments (including wired or wireless communication environments, and distributed or non-distributed networks) operating with any of a number of different electronic devices and according to various similar or alternative protocols or specifications.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments, and how the invention can be implemented for non-hazardous as well as hazardous materials.

One embodiment of the invention provides a mechanism that enables battery-powered or other power sensitive communication devices to utilize the hibernation power saving mechanism offered by existing protocols such as, for example, the WiMedia MAC protocol. In this example implementation, the invention can be implemented to provide a new dimension of traffic indication (for example, at the WiNET sub-layer), by enabling devices to go into hibernation mode unless they have traffic to transmit or they are “woken up” by their neighbors. This can allow devices to dynamically change the durations of hibernation and active modes via WiNET negotiation.

For energy efficiency, any or all of the following features can be implemented in accordance with various embodiments of the invention. In accordance with one feature, in circumstances where there is no data buffered for transmission for a network device, that device is permitted to hibernate preferably for as long as possible or practical and is thus preferably active for as short a time period as possible or practical.

In accordance with another feature, where there is data buffered for transmission for a network device, that receiving device can be permitted to remain active for as long as needed to receive the data. Preferably, that receiving device remains active only as long as needed to receive the data.

In accordance with yet another feature, to help prevent the target from hibernating for too long, a mechanism can be provided for the traffic source to provide information to the target regarding the next time that the source may have traffic for that target. This expected time can, for example, be based on traffic statistical models, known requirements or other methods used at the source device.

Inherently, in many situations, fixed duty cycles do not perform well in all situations. Because the active and hibernation periods affect throughput and energy consumption, fixed duty cycles for these periods may not always provide optimum performance. If the active period is chosen to be too small, there may not be enough time available to send or receive traffic, potentially degrading throughput. If the active period is too long, the device has less time to hibernate, potentially increasing the energy consumption. Also, if the hibernation period is too long, then the source device may need to wait a long period of time before the target is active, potentially causing throughput degradation and buffer overflows. Thus, fixed periods do not always lead to optimal power conservation.

In the example environment, the Traffic Indication Map (TIM) Information Element (IE) provides a mechanism to indicate that an active device has data buffered for transmission via Prioritized Contention Access (PCA) for one or more of its neighbors. This mechanism allows a device that is not expecting traffic during a certain superframe to go into a power save mode, such as a sleep state, thus saving the device's energy. Because TIM IE is used to indicate traffic within the superframe, it can be considered as an intra-superframe traffic indication mechanism.

In accordance with one embodiment of the invention, a new dimension of traffic indication can be provided. In terms of the example environment, for instance, at the WiNET sub-layer level an inter-superframe traffic indication mechanism can be provided. This mechanism in one embodiment is orthogonal to the TIM IE mechanism, and can improve devices' energy savings. In one implementation, a network device is permitted or instructed to go into the hibernation mode whenever it does not have traffic to transmit. The device, however, can be configured so as to not remain in hibernation mode for longer than a given period so that it can receive traffic information from other network devices that may wish to communicate with it. Upon receiving this traffic information, the network device will be able to determine whether to remain awake or when to next reawaken to receive the intended data.

In terms of the example environment, in one embodiment the device can remain asleep for a variable period of X superframes, and awaken in order to receive traffic information from other network devices that may wish to communicate with it (for example, “WiNET traffic indications” from its WiNET neighboring devices in the example environment). The indication, which can be referred to as a WiNET Traffic Indication (WTI) (although other designations are possible), can be encoded in the source's beacon. For example the indication can be encoded in the WiNET Application Specific Information Element (ASIE). Similar to the TIM IE, it can be implemented to contain the DevAddr or other identification of every neighboring device for which WiNET traffic is buffered. Additionally, the traffic indication (for example, the WTI) can be used to indicate a recommended hibernation period for each one of those neighbors.

In one embodiment, a first network device that wishes to communicate with one of its hibernating neighbors can wait until that neighbor goes into an active mode. In one embodiment, this can be designated as a predetermined maximum latency of X superframes. When the neighbor goes into the active mode, that neighbor's identification (for example, its DevAddr) and the recommend hibernation period can be included in the first device's traffic indication. Note that in the example environment the MAC spec mandates that the hibernating devices advertise the hibernation period (i.e., X), so the source device may know when the target will be active.

A device that receives a traffic indication that contains its identification (e.g., DevAddr) can be configured to remain in the active mode for as long as traffic indications included in received beacons contain its identification. The traffic indicator thus acts as a “wake up” message for a network device. This allows the device to remain asleep as long as it does not need to transmit information, and to awaken only periodically to check for traffic indications affecting it. Thus, the invention can be implemented in one embodiment so that the default behavior is hibernation unless wake up calls are received. This can increase the hibernation period, thus improving network devices' energy consumption.

In one embodiment as mentioned above, the sending device can include a recommended hibernation period. This recommended hibernation period can provide information to the target device regarding how long the device should hibernate before waking up again to receive traffic from the source device sending this recommendation. Various methodologies can be used to determine this parameter, and may be implementation specific. Preferably, the parameter takes into account the expected traffic patterns at the source device.

Whether the target device follows this recommend hibernation period may depend on a number of factors such as its power capabilities, QoS (Quality of Service) constraints, network requirements, other scheduled communications activities, etc. In one embodiment, whether it follows the recommendation or not, the invention can be implemented such that the source device will hear the hibernation period (part of MAC rules), and wait until the target is up again to send the data. The source can then keep the target active by including the target address in the traffic indicator so long as there is traffic for that target.

Thus, according to the various embodiments described above, one feature that can be provided is that in scenarios where no data is buffered for transmission to a network device, that device will not receive a traffic indicator that contains its identification, and is able to hibernate. Of course, if that device has other activities to perform or other requirements, it may awaken for other reasons. On the other hand, where there is data buffered for transmission to a target network device, or it is otherwise known that the target is designated to receive traffic, the target device receives a traffic indicator that contains its identification.

The target device can also receive a recommended hibernation period or other indication of when the communication is desired or scheduled. As such, the target device can transition to (or remain in) the active mode to receive this traffic at the proposed or desired time. Thus, a dynamic wake up period can be provided allowing the hibernation and wake up times to be tailored to ongoing or anticipated network activities for a given device.

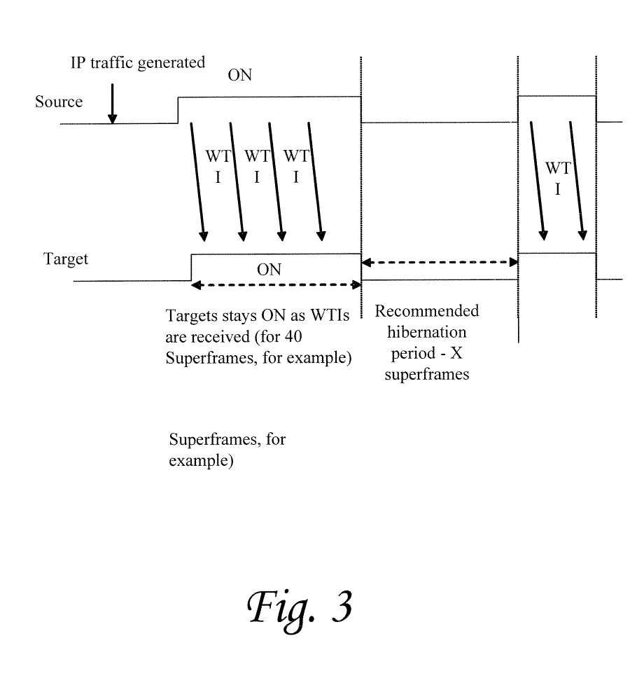

FIG. 3 is a diagram illustrating one example of the proposed mechanism. Let us assume that some IP traffic is buffered for transmission at the WiNET source. If the source is aware of when the target will wake up (for example, via MAC rules or other protocol), the source waits until the target is designated to be awake before sending the traffic indicator (for example, the WTI). Where the source has no other designated activities, the source can also remain in the hibernation mode, and wake up only right before the target wakes up (or otherwise be awake for some overlapping period.)

The source device goes into the active mode and transmits its traffic indicator identifying the target device. In one embodiment, the source device can wait until it detects the target beacon, indicating the target is active. Once the target is active, the source includes the target identification (e.g., the DevAddr) in its traffic indicator (e.g., WTI) encoded in the beacon. In one embodiment, the source device keeps including the target indicator in the beacon as long as there is data buffered for the target.

When no more data is buffered at the source node for that target, the source device recommends that the target hibernate. In one embodiment, the source device recommends that the target hibernate for X communication windows (e.g., superframes 104). The target may take that recommendation as an indication of when the next burst of data from source may come in. Of course, the target may have received other recommendations from other sources it communicates with or may otherwise have network requirements. Therefore, the target may not follow the recommended hibernation duration, but use it in determining the best hibernation duration to meet its own requirements or the expected traffic requirements of all its sources. Thus, depending on other activities, both the source and the target can now hibernate and wake up later to exchange data. Just before hibernation, both of them announce their hibernation period based on MAC rules. Thus, the Source will be able to determine the Target's planned hibernation period, regardless of the recommendations made.

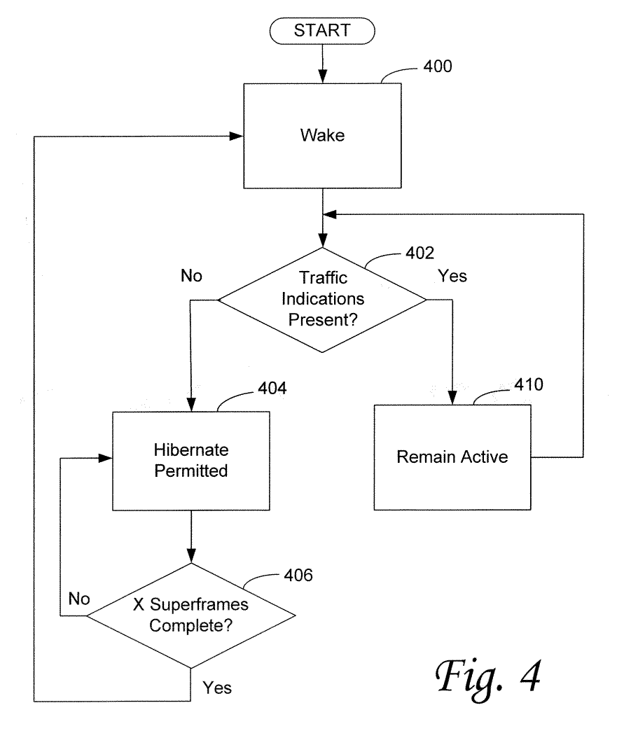

FIG. 4 is a flowchart illustrating an example method in accordance with the systems and methods described herein. The method can be implemented in many different devices, including, for example, network devices such as, a cellular phone, PDA, video player, digital camera, camcorder, HDTV, PC, modem, gaming console, etc. A target device can wake up in step 400. For example, if the target device is in a hibernation state, the target device can wake up after a predetermined number of superframes. In step 402 the method can check for traffic indications. When traffic indications are present the target device receiving the traffic indication can remain active, as illustrated in step 410. In one embodiment the target device can continue to remain active as long as traffic indications continue to be received with each superframe, as illustrated by the return loop between steps 402 and 410 of FIG. 4.

A traffic indication can include, for example, a target device identification (e.g., DevAddr). Including a target device identification in a traffic indication can signify that another device has data to transmit to the target. Additionally, including a target device identification in a traffic indication can also signify that another device expects to have traffic for the target at a particular time in the future. This expected time can, for example, be based on traffic statistical models, known requirements, or other models.

This traffic indication can indicate a predetermined number of superframes or a predetermined period of time over which the target device is recommended to remain active. Thus, the target device can become active, i.e., wake up, after a hibernation period and remain active for a predetermined number of superframes, or a period of time, depending on the traffic indication. For example, in one embodiment, when the target device receives a traffic indication it knows to remain active for the next superframe, and to continue to monitor for subsequent traffic indicators prior to each superframe. In another embodiment, the traffic indicator can provide an indication of the number of periods (e.g., superframes) to remain awake to receive the anticipated traffic load.

When a source has no more data to send, it can send a recommended hibernation period. It will be understood that in some embodiments, the target device can set its own hibernation period based on other activities, e.g., its sending data, etc. In other words, other factors can be used to determine X. Thus, the target device may or may not follow the recommended hibernation period.

For example, assume that a target device is in communication with a first source device. When the first source device has no more data to send it can send a recommended hibernation period of 5 superframes, e.g., when the first source device will have more data to send in 5 superframes. Assume that a second source device has indicated to the target device that the second source device will have data for the target device in 3 superframes. In many cases the target device may hibernate for only 3 superframes so that it can wake up and receive the data from the second source device.

When no traffic indication is present the target device can be allowed to hibernate in step 404. The target device can be allowed to hibernate for a predetermined number of superframes, X, step 406. Alternatively, the target device can be allowed to hibernate for a predetermined period of time. After the predetermined number of superframes, X, or the predetermined period of time the target device can wake in step 400 and determine if traffic indications are present in step 402. Thus, the method can repeat, allowing the network device to, for example, conserve battery power by going into a hibernation state unless the network device has traffic to transmit, the network device is “woken up” by its neighbors, or the device needs to wake up simply to check to see if data is available.

Additionally, in another embodiment, the target device can remain active for a predetermined period of time, rather than as long as a traffic indication is present. For example, in one embodiment the target device can remain active for a predetermined period of time, e.g., after the predetermined hibernation period. Thus the target device can remain awake while determining if other traffic indications are present. Additionally, the target device can remain active in state 410 as long as one or more traffic indications are present.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed:

1. A method of determining when a network device can hibernate, comprising:
waking from a hibernation state at a predetermined time;
determining if a traffic indicator is received from another network device;
if a traffic indicator is received, remaining awake for a predetermined awake time period, wherein the predetermined awake time period is at least one superframe.

2. The method of claim 1, further comprising continuing to determine if a traffic indicator is present and remaining awake as long as the traffic indicator is present.

3. The method of claim 1, wherein the predetermined awake time period comprises a single superframe.

4. The method of claim 1, wherein the predetermined awake time period comprises multiple superframes.

5. The method of claim 1, further comprising determining that a traffic indicator is not present and hibernating for a predetermined hibernation time period based on the determination.

6. The method of claim 5, further comprising receiving a recommended hibernation time period.

7. The method of claim 6, wherein the predetermined hibernation time period comprises a single superframe.

8. The method of claim 6, wherein the predetermined hibernation time period comprises multiple superframes.

9. The method of claim 1, wherein the traffic indicator comprises the occurrence of a beacon containing an identification.

10. The method of claim 1, wherein the traffic indicator indicates that data is available.

11. The method of claim 1, wherein the network device comprises a WiMedia-MBOA compliant device.

12. A network device comprising:
a memory, the memory configured to store instructions;
a processor coupled to the memory and configured to execute the instructions to perform the following steps:
causing the electronic device to wake from a hibernation state at a predetermined time;
determining if a traffic indicator is received from another network device;
if a traffic indicator is received, causing the electronic device to remain awake for a predetermined awake time period, wherein the predetermined awake time period is at least one superframe.

13. The network device of claim 12, further comprising continuing to determine if a traffic indicator is present and remaining awake as long as the traffic indicator is present.

14. The network device of claim 12, wherein the predetermined awake time period comprises a single superframe.

15. The network device of claim 12, wherein the predetermined awake time period comprises multiple superframes.

16. The network device of claim 12, further comprising determining that a traffic indicator is not present and hibernating for a predetermined hibernation time period based on the determination.

17. The network device of claim 16, further comprising receiving a recommended hibernation time period.

18. The network device of claim 17, wherein the predetermined hibernation time period comprises a single superframe.

19. The network device of claim 17, wherein the predetermined hibernation time period comprises multiple superframes.

20. The network device of claim 12, wherein the traffic indicator comprises the occurrence of a beacon containing an identification.

21. The network device of claim 12, wherein the traffic indicator indicates that data is available.

22. The network device of claim 12, wherein the network device comprises a WiMedia-MBOA compliant device.

23. An apparatus for determining when a network device can hibernate, comprising:
means for waking from a hibernation state at a predetermined time;
means for determining if a traffic indicator is received from another network device; and
means for remaining awake for a predetermined awake time period if a traffic indicator is received, wherein the predetermined awake time period is at least one superframe.

24. The apparatus of claim 23, further comprising means for continuing to determine if a traffic indicator is present and remaining awake as long as the traffic indicator is present.

25. The apparatus of claim 23, wherein the predetermined awake time period comprises a single superframe.

26. The apparatus of claim 23, wherein the predetermined awake time period comprises multiple superframes.

27. The apparatus of claim 23, further comprising means for determining that a traffic indicator is not present and hibernating for a predetermined hibernation time period based on the determination.

28. The apparatus of claim 27, further comprising means for receiving a recommended hibernation time period.

29. The apparatus of claim 28, wherein the predetermined hibernation time period comprises a single superframe.

30. The apparatus of claim 28, wherein the predetermined hibernation time period comprises multiple superframes.

31. The apparatus of claim 23, wherein the traffic indicator comprises the occurrence of a beacon containing an identification.

32. The apparatus of claim 23, wherein the traffic indicator indicates that data is available.

33. The apparatus of claim 23, wherein the apparatus comprises a WiMedia-MBOA compliant device.

34. A computer-readable medium having computer-executable instructions for causing a processing device to perform a method of determining when a network device can hibernate, the method comprising:
waking from a hibernation state at a predetermined time;
determining if a traffic indicator is received from another network device;
if a traffic indicator is received, remaining awake for a predetermined awake time period, wherein the predetermined awake time period is at least one superframe.

35. The computer-readable medium of claim 34, wherein the method further comprises continuing to determine if a traffic indicator is present and remaining awake as long as the traffic indicator is present.

36. The computer-readable medium of claim 34, wherein the predetermined awake time period comprises a single superframe.

37. The computer-readable medium of claim 34, wherein the predetermined awake time period comprises multiple superframes.

38. The computer-readable medium of claim 34, wherein the method further comprises determining that a traffic indicator is not present and hibernating for a predetermined hibernation time period based on the determination.

39. The computer-readable medium of claim 38, further comprising receiving a recommended hibernation time period.

40. The computer-readable medium of claim 38, wherein the predetermined hibernation time period comprises a single superframe.

41. The computer-readable medium of claim 38, wherein the predetermined hibernation time period comprises multiple superframes.

42. The computer-readable medium of claim 34, wherein the traffic indicator comprises the occurrence of a beacon containing an identification.

43. The computer-readable medium of claim 34, wherein the traffic indicator indicates that data is available.

44. The computer-readable medium of claim 34, wherein the network device comprises a WiMedia-MBOA compliant device.
